(19) United States
(12) Patent Application Publication
(10) Pub. No.: US 2012/0141959 A1
(43) Pub. Date: Jun. 7, 2012

(54) CROWD-SOURCING THE PERFORMANCE OF TASKS THROUGH ONLINE EDUCATION

(75) Inventors: Luis Alfonso von Ahn Arellano, Pittsburgh, PA (US); Severin Benedict Hans Hacker, Pittsburgh, PA (US)

(73) Assignee: CARNEGIE MELLON UNIVERSITY, PITTSBURGH, PA (US)

(21) Appl. No.: 13/313,905

(22) Filed: Dec. 7, 2011

Related U.S. Application Data
(60) Provisional application No. 61/459,101, filed on Dec. 7, 2010.

(51) Int. Cl. G09B 19/06

(52) U.S. Cl. 434/157

(57) ABSTRACT

A method and system of crowd-sourcing the performance of tasks through online education. In some embodiments, a method accesses content in a first language and identifies multiple segments within the content. Each of the multiple segments are provided to multiple users, who are requested to translate the segment from the first language to a second language. Multiple translations are received for each of the multiple segments. A correct translation is determined for each segment based on the multiple translations associated with the segment.

### RELATED APPLICATION

This application claims the priority benefit of U.S. Provisional Application No. 61/459,101, entitled “METHODS, APPARATUSES, AND SYSTEMS FOR CROWD-SOURCING THE PERFORMANCE OF TASKS THROUGH ONLINE EDUCATION,” filed Dec. 7, 2010, the disclosure of which is incorporated herein by reference in its entirety.

### STATEMENT REGARDING FEDERALLY-SPONSORED RESEARCH OR DEVELOPMENT

This invention was made with partial government support under NSF grant IIS-0968487. The government has certain rights in this invention.

### TECHNICAL FIELD

The present disclosure generally relates to systems and methods that provide educational benefits while supporting the crowd-sourced performance of tasks.

### BACKGROUND

Although computers have advanced dramatically in recent years, they still cannot perform many tasks that are relatively easy for humans. For example, computers are not as accurate as humans when describing (or “tagging”) the contents of an image, translating text to a different language, or subtitling video content. Human involvement remains important to accurately perform these types of tasks.

### BRIEF DESCRIPTION OF THE DRAWINGS

Some embodiments are illustrated by way of example and not limitation in the figures of the accompanying drawings.

FIG. 1 is a block diagram of an environment within which an example embodiment may be deployed.

FIG. 2 is a block diagram of a crowd-sourcing manager, in accordance with some embodiments of the present invention.

FIG. 3 is a flow diagram of a method, in accordance with an embodiment, of crowd-sourcing the translation of content.

FIG. 4 is a flow diagram of a method, in accordance with an embodiment, of managing translation of content segments by a user.

FIG. 5 depicts, in accordance with an embodiment, a portion of a user interface displaying a content segment for translation by a user.

FIG. 6 depicts, in accordance with an embodiment, a hierarchy of user skill levels.

FIG. 7 is a flow diagram of a method, in accordance with an embodiment, of annotating image content with a second language.

FIG. 8 is a block diagram of a machine in the example form of a computer system within which a set of instructions, for causing the machine to perform any one or more of the methodologies discussed herein, may be executed.

### DETAILED DESCRIPTION

Example systems and methods of crowd-sourcing the performance of tasks through online education are described. In the following description, for purposes of explanation, numerous specific details are set forth in order to provide a thorough understanding of example embodiments. It will be evident, however, to one skilled in the art that the present invention may be practiced without these specific details.

The systems and methods described herein provide incentives for users (e.g., individuals) to participate in crowd-sourcing approaches to the performance of tasks. In some embodiments, the systems and methods teach users a foreign language in response to the user's translation of text or other content from one language to another. In other embodiments, the systems and methods provide foreign language education as the user describes or tags video content, audio content, pictures, and the like. The educational benefit associated with the described systems and methods provides an incentive for users to participate in the crowd-sourced performance of tasks. The terms “user” and “student” are used interchangeably herein.

In some embodiments, content translation, video content description, and other tasks are performed by multiple users at a lower cost than existing systems and methods. In these embodiments, users are motivated to perform the tasks in exchange for learning a new language at no cost to the user. Translating content, such as online content, into different languages allows a greater number of individuals to access the content (e.g., individuals who could not understand the original language associated with the content). Additionally, attaching metadata such as transcriptions or descriptive tags to content (e.g., video content) allows the content to be indexed and searched based on the metadata. When translating or tagging large amounts of content, hiring individuals to perform these tasks may result in substantial costs due to the time involved to translate or tag the large quantities of content. The crowd-sourcing systems and methods described herein significantly reduce the costs involved by encouraging multiple users to annotate, describe, transcribe or tag the content in exchange for learning a new language.

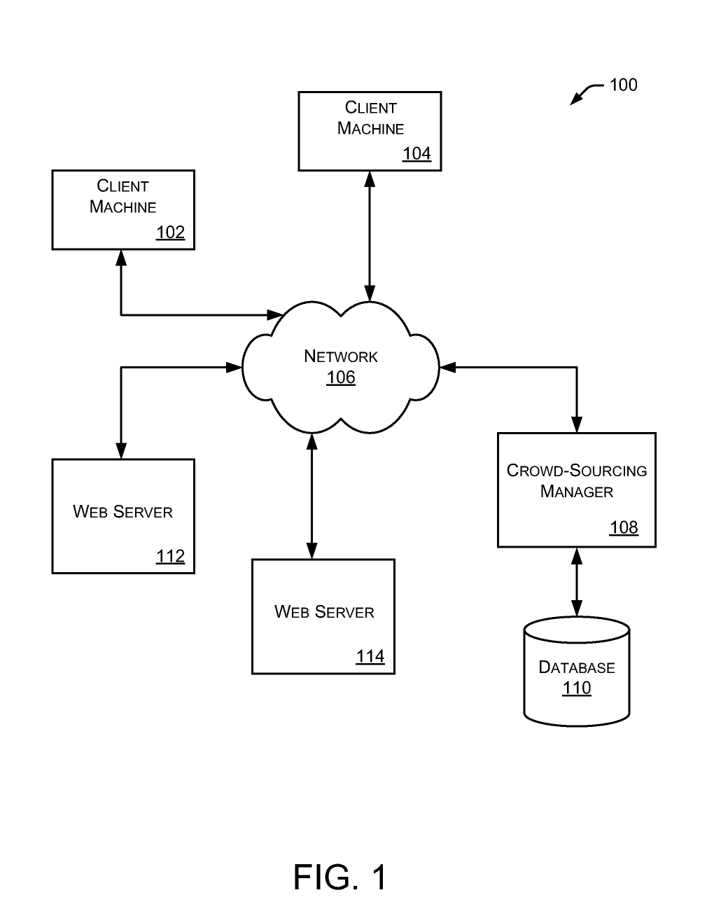

FIG. 1 is a block diagram of an environment 100 within which an example embodiment may be deployed. Environment 100 includes client machines 102 and 104 coupled to a data communication network 106 (e.g., the Internet, a Local Area Network (LAN) or Wide Area Network (WAN)). A crowd-sourcing manager 108 and web servers 112 and 114 are also coupled to data communication network 106. Client machines 102 and 104 include a browser application for accessing crowd-sourcing manager 108 and web servers 112 and 114. For example, client machine 102 may access various content and services hosted by web servers 112 and 114. Similarly, client machines 102 and 104 can communicate with crowd-sourcing manager 108 through data communication network 106 to perform the procedures and functions described herein. A database 110 is coupled to crowd-sourcing manager 108 and stores various data associated with the operation of the crowd-sourcing manager. Although two client machines 102, 104 and two web servers 112, 114 are shown in FIG. 1, alternate embodiments may include any number of client machines coupled to any number of web servers. Alternate embodiments may further include additional types of data sources (or content sources) not shown in FIG. 1.

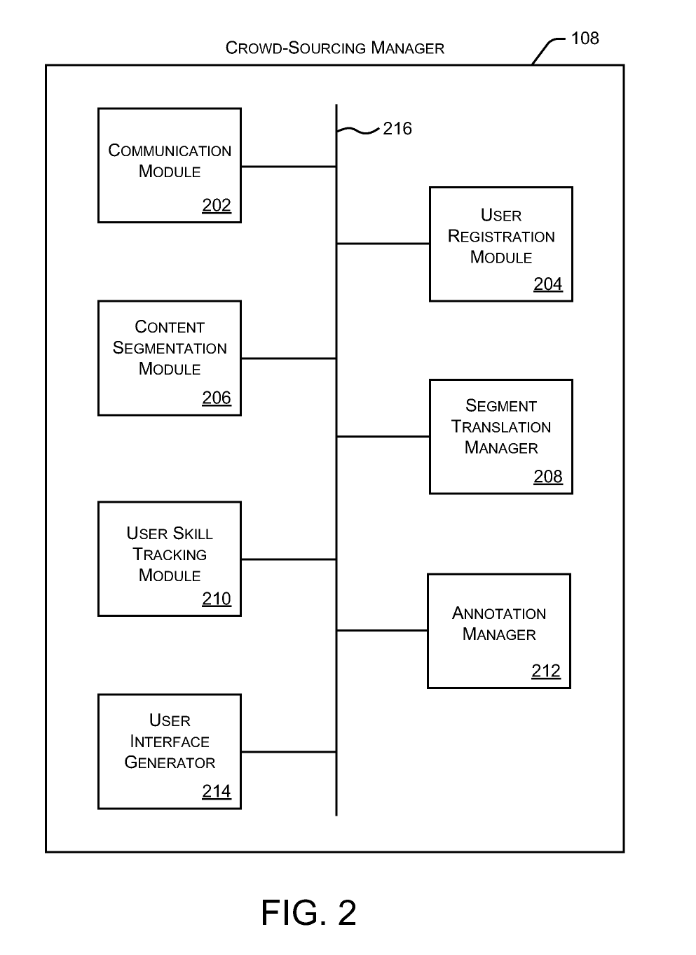

FIG. 2 is a block diagram of crowd-sourcing manager 108, in accordance with some embodiments of the present invention. In various embodiments, crowd-sourcing manager 108 implements computer programs, logic, applications, methods, processes, or software for crowd-sourcing the performance of tasks as described herein. In the embodiment of FIG. 2, crowd-sourcing manager 108 includes a communication module 202 that allows crowd-sourcing manager 108 to communicate with other components and systems (e.g., client machines 102, 104 and web servers 112, 114 shown in FIG. 1). A user registration module 204 allows multiple users to register with crowd-sourcing manager 108 and learn a new language by performing translation tasks, as discussed herein.

Crowd-sourcing manager 108 further includes a content segmentation module 206 that divides content (e.g., web page content, documents, images, and video content) into multiple segments. A segment translation manager 208 coordinates the translation of multiple segments by multiple users, as described herein. A user skill tracking module 210 monitors language skill levels associated with various users and determines when to increase or decrease a user's language skill level. As discussed herein, a user's language skill level is a factor in determining which segments to provide to the user.

Crowd-sourcing manager 108 also includes an annotation manager 212 that coordinates that annotation of various content, such as video content, pictures and audio content. Annotation manager 212 supports the annotation of non-textual content with textual description and tagging information. A user interface generator 214 creates a user interface to display various content translation and annotation information to a user. A communication bus 216 is coupled to the various modules and components in crowd-sourcing manager 108, thereby allowing the modules and components to communicate with one another. Communication bus 216 may use any communication protocol and any communication media.

In alternate embodiments, crowd-sourcing manager 108 may include fewer or more modules apart from those shown in FIG. 2. The various modules and components in segment translation manager 208 may be in the form of software that is processed by a processor. The described modules and components may be adapted, and/or additional structures may be used to provide alternative or additional functionalities beyond those specifically discussed with reference to FIG. 2.

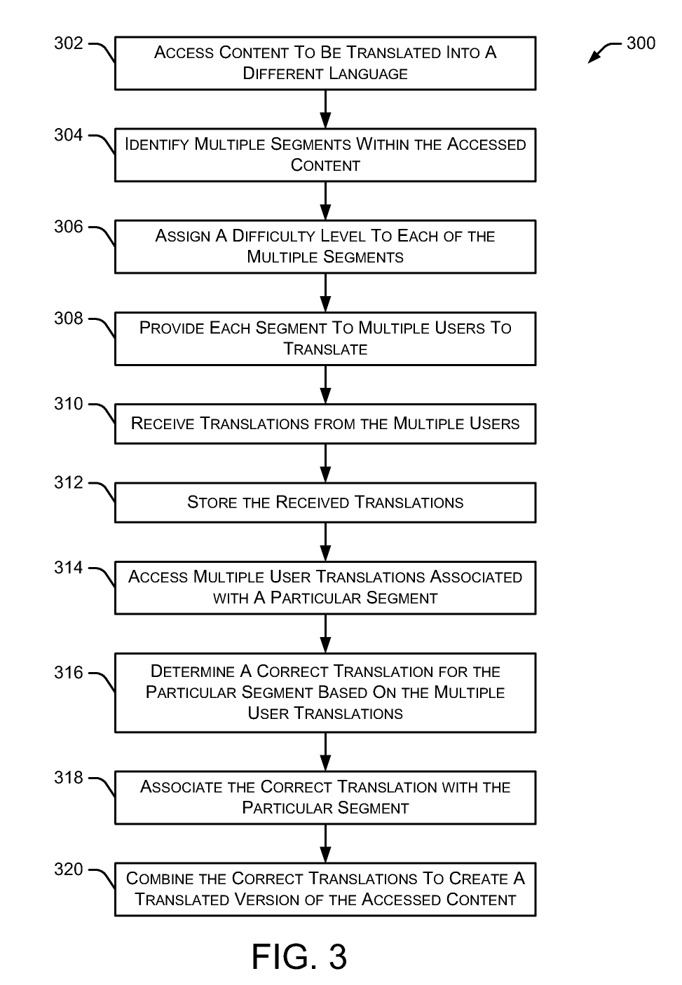

FIG. 3 is a flow diagram of a method 300, in accordance with an embodiment, of crowd-sourcing the translation of content. In a particular embodiment, at least a portion of method 300 is implemented by a processor or computing system, such as one or more of the processors and computing systems discussed herein. Initially, the method accesses content to be translated into a different language at 302. The accessed content includes any type of content, such as text, pictures, video content, audio clips, and the like. The content is accessed from any data source, such as a web server.

After accessing the content, the method identifies multiple segments within the content at 304. The multiple segments include, for example, sentences or phrases in text, temporal portions of audio or video content, and the like. A difficulty level is assigned to each of the multiple segments at 306. The difficulty level indicates an expected difficulty a user will experience when attempting to translate the segment into a different language. As discussed herein, this difficulty level is used to match appropriate segments with users based on the user's language skill level. In alternate embodiments, the difficulty level is associated with a particular category (e.g., common phrases, intermediate complexity, and high complexity).

The method of FIG. 3 continues as each segment is provided to multiple users to translate into a different language at 308. In different embodiments, each segment is provided to any number of users. In a particular implementation, each segment is provided to at least three users and less than fifty users. The segments may be provided to the multiple users over a period of time, such as several hours or several days. In some embodiments, each segment is provided to multiple users through a data communication network (e.g., data communication network 106 shown in FIG. 1). After each user translates a segment, the translation is received at 310. In some embodiments, the translations are received from multiple users through data communication network 106 shown in FIG. 1. The translations are then stored for future analysis and processing at 312. In some embodiments, the translations are stored in a database with other translations for the same segment as well as other segments associated with the accessed content. At a future time, the method accesses the multiple user translations associated with a particular segment at 314.

The multiple user translations are analyzed to determine a correct translation for the particular segment at 316. In some embodiments, the correct translation is determined for a particular segment by analyzing all received translations for the segment and identifying a most common translation among all received translations. In other embodiments, a translation must represent a majority of all received translations to be considered a correct translation for a particular segment. In particular embodiments, the correct translation is determined for a particular segment by having users vote on two or more translations submitted by other users. For example, a portion of the multiple users are selected and shown different translations of the same segment by other users. Each of the selected users vote for a best translation for the segment.

After determining the correct translation for a particular segment, the correct translation is associated with the segment at 318. Finally, the correct translation for each of the plurality of segments within the content are combined to create a translated version of the accessed content at 320. The translated version of the content is then available to provide an alternate language for users to access the original content. Additionally, the users who performed the translation tasks (translating one or more segments) receive the benefit of learning or enhancing their knowledge of a new language.

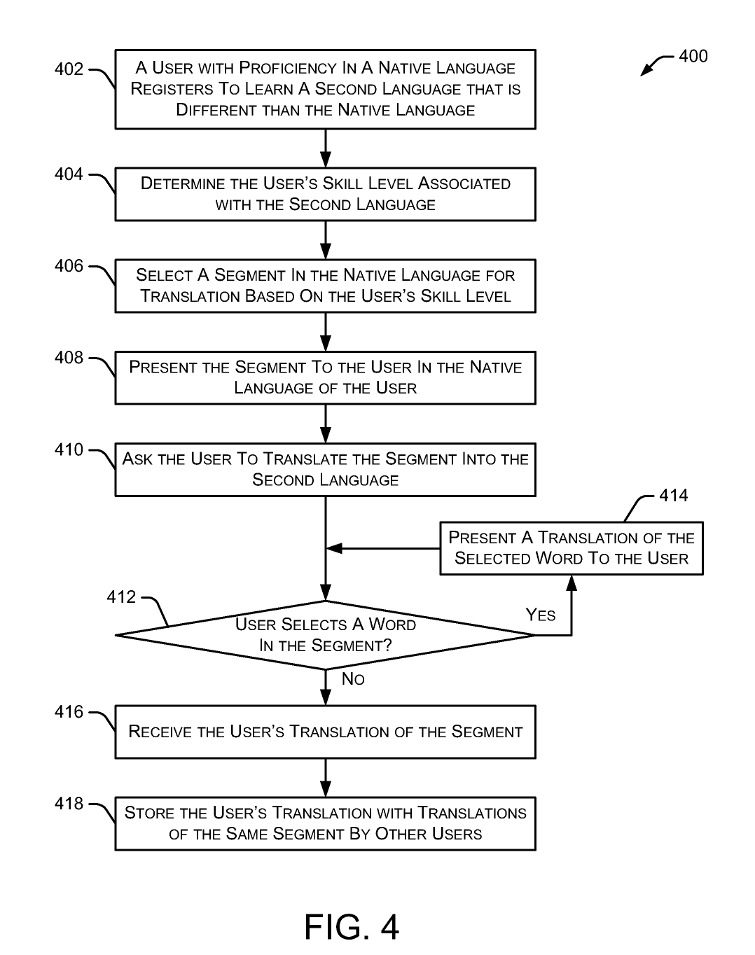

FIG. 4 is a flow diagram of a method 400, in accordance with an embodiment, of managing translation of content segments by a user. In a particular embodiment, at least a portion of method 400 is implemented by a processor or computing system, such as one or more of the processors and computing systems discussed herein. Initially, a user with proficiency in a native language registers to learn a second language (e.g., a second language selected by the user) that is different than the native language at 402. Method 400 determines the user's skill level associated with the second language (the language being learned by the user) at 404. In some embodiments, a user is given a test or other evaluation to determine their current language skill level.

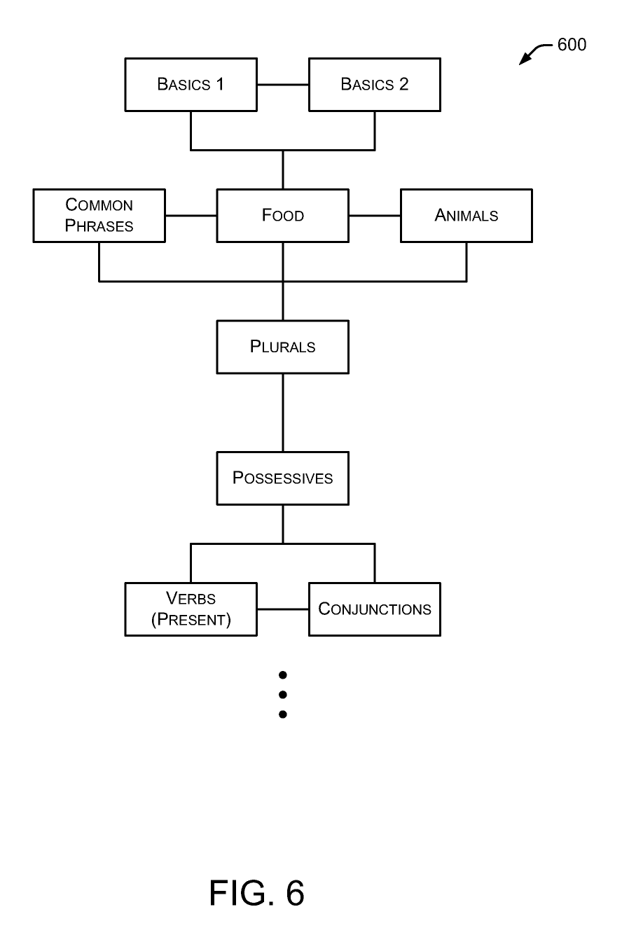

The method 400 of FIG. 4 continues by selecting a content segment in the native language for translation based on the user's language skill level at 406. As discussed herein, the segment is a portion of a larger block of content (e.g., web site content or a document) that is being translated from the native language to another language. In some embodiments, a content segment is selected that will advance the language education of the user. For example, if the user was just taught a particular word in the new language, the method may select a content segment that contains the particular word. In other embodiments, a content segment is selected based on a current skill level category associated with the user, such as the categories discussed herein with respect to FIG. 6. For example, if a user is currently learning colors in the new language, the method may select a content segment that refers to at least one color.

The method presents the segment to the user in the native language of the user at 408. For example, the segment may be presented by displaying text, playing an audio clip, showing a video image or playing a video sequence to the user who will attempt to translate the segment. The method continues by asking the user to translate the segment into the second language at 410. In alternate embodiments, users with low skill levels in the second language (i.e., a non-native language of the user) are initially presented with segments in the second language. In these alternate embodiments, each user is asked to translate the segment from the second language into the user's native language. When the user's skill level increases to a predetermined level, method 400 begins presenting the segment in the native language of the user and asks the user to translate the segment into the second language.

When presenting a segment to a user that includes one or more displayed words, method 400 offers a translation of individual words to assist the user in translating the sentence, phrase or other sequence of multiple words. The user activates this translation of individual words by, for example, hovering a pointer over the word or otherwise selecting the word to be translated. If the user selects a word at 412, method 400 presents a translation of the selected word to the user at 414. This process of selecting individual words to be translated can be repeated for as many words as desired by the user.

Method 400 continues by receiving the user's translation of the segment at 416 in the second language. The user's translation is stored along with translations of the same segment by other users at 418. The above process may be repeated by returning to 406 to select another segment for the user to translate.

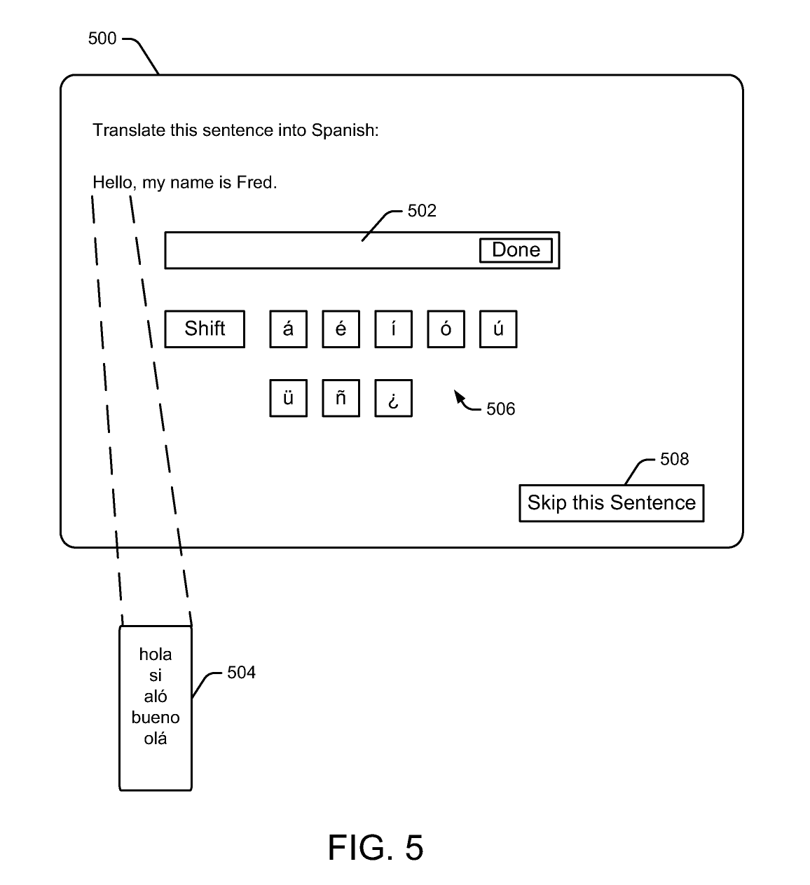

FIG. 5 depicts, in accordance with an embodiment, a portion of a user interface 500 displaying a content segment for translation by a user. User interface 500 requests the user to translate the sentence “Hello, my name is Fred.” into Spanish. The user enters the translated sentence into box 502 and clicks the “Done” button when finished with the translation. If the user needs help translating a particular word, they can select a word by, for example, hovering a graphical pointer over the word. In the example of FIG. 5, the user has activated the word “Hello,” which causes a separate display box (or display window) 504 to appear with possible Spanish translations for the word “Hello.” The user can individually select multiple words in the sentence to assist with translating the sentence into Spanish.

User interface 500 also includes multiple character buttons 506 used in common Spanish words. These characters are not typically part of an English keyboard. So, the user can click on the character buttons 506 as necessary to enter the Spanish characters needed in the translation of the sentence. If a user is not sure how to translate a particular sentence, they can skip the sentence by clicking on button 508.

FIG. 6 depicts, in accordance with an embodiment, a hierarchy 600 of user skill levels (also referred to as “categories”). In the example of FIG. 6, a beginning user (e.g., someone starting to learn the new language) starts with one of the top two categories (Basics 1 or Basics 2). As the user's language skill level increases, they move to skill levels/categories located lower in hierarchy 600. The organization of hierarchy 600 is based on language learning techniques, such as learning how to form sentences (e.g., learning about nouns before using adjectives).

In some embodiments, skill levels on the same level of hierarchy 600 are of equal difficulty. For example, a user who has moved to the second level of hierarchy 600 (Common Phrases—Food—Animals) can receive segments to translate in any of the three categories in the second level of the hierarchy. However, more advanced categories positioned below the second level of hierarchy 600 remain locked (indicating that the user's skill level is not sufficient to accurately translate segments at those levels). A particular hierarchy 600 may include any number of skill levels arranged in any manner. In some embodiments, hierarchy 600 is displayed to users in a manner that shows the user's current skill level as well as the locked skill levels that are not yet available to the user. Hierarchy 600 represents one example of user skill levels. Alternate versions of hierarchy 600 may include different levels arranged in any manner.

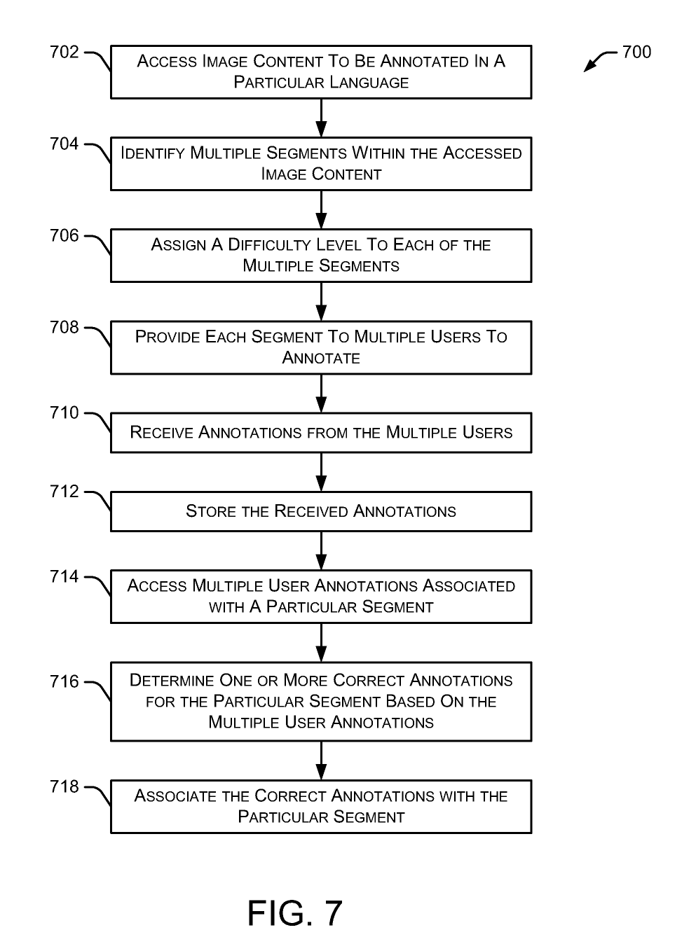

FIG. 7 is a flow diagram of a method 700, in accordance with an embodiment, of annotating image content with a second language. In a particular embodiment, at least a portion of method 700 is implemented by a processor or computing system, such as one or more of the processors and computing systems discussed herein. Annotation refers to providing one or more words that describe the object or action displayed in the image content. These words are useful in indexing, organizing, and searching through the image content to find particular images.

Initially, method 700 accesses image content to be annotated in a particular language at 702. The accessed image content includes, for example, photographs, paintings, video content, and the like. The image content is accessed from any data source, such as a web server.

After accessing the image content, method 700 identifies multiple segments within the accessed image content at 704. The multiple segments include, for example, different images, different portions of an image, and the like. A difficulty level is assigned to each of the multiple segments at 706. The difficulty level indicates an expected difficulty a user will experience when attempting to annotate the segment in the particular language. As discussed herein, this difficulty level is used to match appropriate segments with users based on the user's language skill level.

Method 700 continues as each segment is provided to multiple users to annotate in the different language at 708. The segments may be provided to the multiple users over a period of time, such as several hours or several days. In some embodiments, each segment is provided to multiple users through a data communication network (e.g., data communication network 106 shown in FIG. 1). After each user annotates a segment, the annotation is received at 710. In some embodiments the annotation is received from data communication network 106 shown in FIG. 1. The annotations are stored for future analysis and processing at 712. In some embodiments, the annotations are stored in a database with other annotations for the same segment as well as other segments associated with the accessed image content. At a future time, method 700 accesses the multiple user annotations associated with a particular segment at 714.

The multiple user annotations are analyzed to determine one or more correct annotations for the particular segment at 716. A particular segment may have multiple correct annotations. For example, a segment showing a boy riding a bike in a park may have the following correct annotations: boy, bike, riding, and park. In some embodiments, the most common annotations are considered as the correct annotations. After determining the one or more correct annotations for a particular segment, the correct annotations are associated with the segment at 718.

In some embodiments, method 700 utilizes a user interface similar to interface 500 shown in FIG. 5. When annotating content, the user interface may display the content to be annotated along with a box in which to enter the annotation. In particular embodiments, the user interface may display a sentence or phrase that is missing one word. The user is asked to complete the sentence by providing the missing word such that the sentence accurately describes the content to be annotated. The annotation may describe an object in the content, an activity taking place in the content, and the like.

The systems and methods described herein allow users to learn a new language by actively performing tasks that are educational and simultaneously produce useful data. As discussed, these tasks include translating text, annotating images, and transcribing videos (e.g., providing descriptive text associated with a portion of a video program or other video content). By selecting annotations or translations based on the data provided by multiple users, the described systems and methods can produce valuable metadata for various types of content.

In some embodiments, users are presented with content for which a translation or accurate annotations are known. In this situation, after the user provides a translation or annotation, the described systems and methods provide feedback to the user indicating the accuracy of the translation or annotation provided. This is particularly useful with users that have a low language skill level (e.g., users with little or no knowledge of the language). If the user's translation or annotation is not accurate, the systems and methods provide a correct translation or annotation for the user. By providing immediate feedback regarding the accuracy of the translation or annotation, the user begins to learn the new language. In other situations, when the user is translating or annotating unknown content, the user receives feedback regarding the accuracy of their translation or annotation at a later time. Although the user is not receiving immediate feedback (since the correct result is not yet known), the user does receive future feedback to enhance the language learning process.

In particular embodiments, a user's past success rate in translating or annotating content is considered when evaluating the user's current translations or annotations. For example, if the user has recently annotated known images of dogs correctly, the systems and methods would assign a high level of confidence to the user's identification that a particular image contains a dog. After multiple accurate users have provided the same translation or annotation, the systems and methods determine the accuracy of the translation or annotation with a high degree of confidence.

In some embodiments, when a user accesses a crowd-sourcing manager of the type described herein, the user is presented with a session consisting of a sequence of 20 examples and challenges that the user must solve, designed to last about 15 minutes in total. Each session includes multiple types of examples and challenges, with each type exercising a different skill of the language. Users are given a mix of challenges with known and unknown answers, to balance immediate feedback versus usefulness of their work. When a user enters an incorrect answer for a challenge, and if the correct answer is known by the system, it is shown to the user immediately. At the end of a session, the user is shown their progress with statistics such as the number of challenges they answered correctly (out of the ones that could be graded so far), their current skill level, and the like.

One of the challenge types is the Name Challenge, in which users learn vocabulary at the same time as annotating or tagging images. In the Name Challenge, the user is presented with an image and asked to enter words in the new language to describe the image. When an image is first introduced into the system without any annotations or tags, it is presented as a Name Challenge, but the user's answers are not immediately analyzed. Instead, the user is told that the system does not yet know the answer, and that their input will be used to partially annotate or tag the image. After enough users annotate or tag the image, the most common tags, weighted by each user's measured expertise, are marked as correct. Some of the images presented to the user will have known answers and will be used to provide immediate feedback. Users may or may not be told beforehand whether a challenge has a known answer.

The Name Challenge provides an approach to annotate or tag images for free, which could improve the accuracy of image search engines or the accessibility of Web-based content by providing textual descriptions of images to visually impaired users.

Another challenge is the Describe Challenge, in which users practice describing images in more detail. The users are presented with an image along with a descriptive template that must be completed by the user. The templates are of the form “The <noun> is ______”, or the equivalent in other languages, and users can type anything into a blank space. In some languages where nouns have a gender, or the form “to be” is not used or corresponds to multiple words (such as in Spanish, where it can be “es” or “está”), the users also have to select the appropriate choice for the description to be grammatically correct. This approach may help users learn to generate simple descriptive phrases. As with the previous challenge types, some of the Describe Challenges presented to the users have known answers and provide immediate feedback, whereas others have no known answers, and an answer is marked as correct only when multiple users agree on the answer. If agreement is not reached after a certain number of users enter solutions, the challenge may be removed from the system.

The noun in each Describe Challenge is fixed and is taken directly from the Name Challenge. For example, the Name Challenge may generate results indicating that an image includes a boy, but the Describe Challenge may also indicate (e.g., describe) that the boy is running. The verbs and adjectives collected through this challenge help annotate and tag images more specifically.

Another challenge is the Listen Challenge, in which the user is played an audio clip with one or more words in the foreign language and they have to type what they hear. In addition to exercising listening skills, this challenge employs the user's effort towards transcribing speech in audio and video clips.

Each audio clip in a Listen Challenge includes a few words so that users can easily type all of the words. However, the Listen Challenge can be used to transcribe arbitrarily long pieces of audio by splitting them into smaller segments. To support data collection, this challenge type can be combined with automated speech recognition so that humans expend effort transcribing only the segments that the speech recognizer failed to understand. The transcription algorithm works as follows. First, the algorithm accesses a long audio clip that needs to be transcribed. Automated speech recognition is run on the audio clip, and the segments where the recognizer was likely to have failed are identified by using the confidence score of the recognizer along with a probabilistic language model that determines if there are possible mistakes in the transcription. The segments where the speech recognizer was likely to have failed are then split into clips of an appropriate length (e.g., containing a few words), and presented as Listen Challenges to multiple users. Once there is enough agreement among the users about what is in each segment, all of the answers are combined with the speech recognizer's output to determine a final transcription of the original audio clip.

Another challenge is the Speak Challenge, which teaches users to speak in the foreign language. Users are asked to say a word or phrase into their microphone, and are then given a score of how well they pronounced the utterance. Beginning users are played an audio clip with the utterance beforehand so that they simply have to repeat it back. More advanced users may be shown the text of the phrase they have to speak. Users are provided immediate feedback by running automated speech recognition on their utterance. To improve the accuracy of the speech recognizer, the systems and methods seed its language model with a few words that include the ones the user was asked to pronounce along with some near matches.

Another challenge is the Judge Challenge. Since it is not possible to automatically determine if a user's translation for a Translate Challenge is correct, the system may ask other users to rate the translations using the Judge Challenge. In this challenge, users are given the original source sentence along with multiple translations that were entered by other users, and asked to determine which translations are correct. This also exercises the reading skills of the users. For data quality purposes, Judge Challenges are presented both to users who are native in the source language as well as other users who are native in the target language. In addition, to achieve higher translation accuracy, some of the candidate translations presented can be taken from machine translation systems (in case they are better translations than the ones entered by the users). To ensure that the users are presented with at least one incorrect translation, some of the choices shown can purposely be made grammatically incorrect by adding, removing or reordering words such that a probabilistic language model considers the text unnatural.

Multiple users rate each translation, and the translations with sufficient votes, weighted by the users' expertise, are deemed correct. After a translation is graded, the user who originally entered it as a translation can be provided with delayed feedback about their translation.

A challenge selection algorithm determines which challenge to present to a particular user. It is desirable to select challenges that allow users to learn effectively while also performing a useful task. The challenge selection algorithm considers multiple factors, such as the skill level of a user and the difficulty of a challenge. For both learning and data quality purposes, it is important that users receive challenges of the appropriate difficulty. If the challenges are too easy, the users do not learn new material and may get bored. However, if the challenges are too difficult, the users are not able to answer the challenge. The difficulty of a challenge can be estimated a priori using measures such as syllable count for the Speak Challenge and Flesch-Kincaid Grade Level for the Translate Challenge. The skill level of a user can be measured by how well they perform (or have previously performed) on challenges of a certain difficulty. Once multiple users have attempted a challenge, the challenge's difficulty estimate can be refined based on the success rate of users of a given skill level. Recursively, the skill level of the users can be recalculated using the refined difficulty estimates, and so on.

The selection algorithm can be adaptive and personalized. When a user fails a challenge, the algorithm can provide the user with the same or very similar challenges until they learn the relevant concept. If a user is doing poorly, the algorithm can give easier challenges, whereas if the user answers every challenge correctly, the algorithm can increase the difficulty.

Many people learn more effectively when they are interested in the subject of the lessons or teachings. Thus, in some embodiments, the systems and methods described herein are constructed to provide challenges relating to subjects in which the users are interested. For example, users can specify what types of texts they would like to translate, such as politics, science, celebrity news, and the like. The system also allows users to rate their interest level for each challenge, such that the selection algorithm can provide challenges to users that are more likely to be of interest to the user. Regardless of user interests (and interest level ratings), the systems and methods ensure that the users learn the fundamental concepts associated with the language.

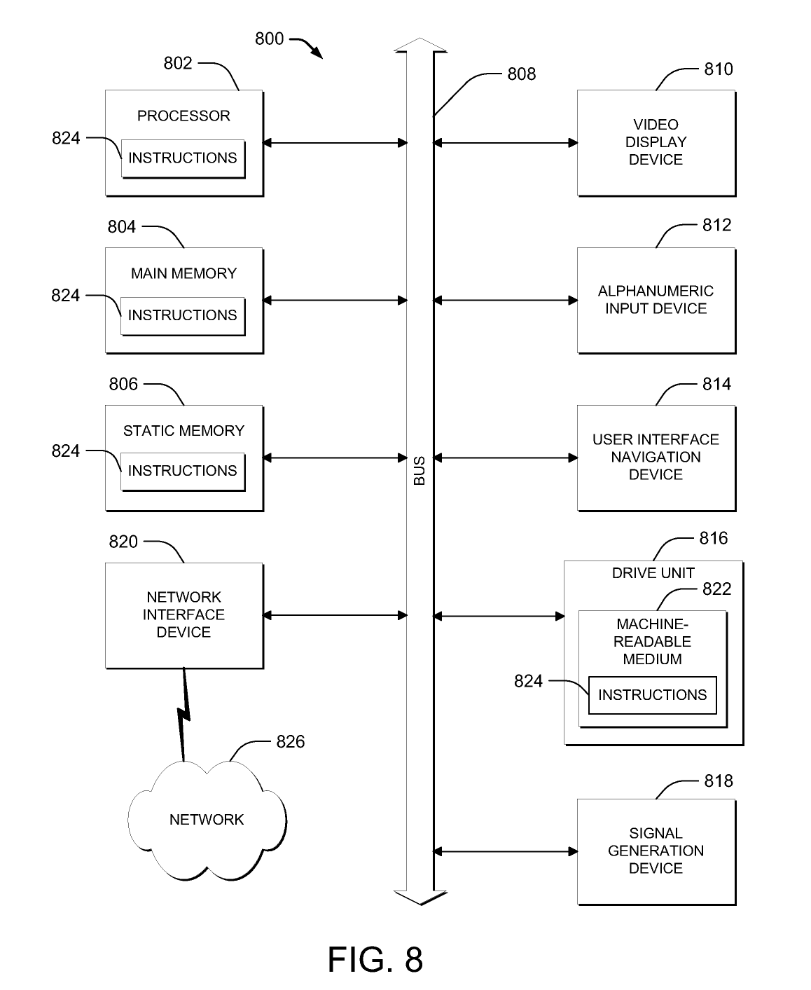

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804, and a static memory 806, which communicate with each other via a bus 808. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. For example, the described systems and methods may provide an educational benefit in other disciplines that by providing incentives for users to access the systems and methods. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing content in a first language;
identifying a plurality of segments within the content;
providing each of the plurality of segments to a plurality of users coupled to a data communication network;
requesting each of the plurality of users to translate the provided segment from the first language to a second language;
receiving via the data communication network a plurality of translations associated with each of the plurality of segments; and
determining, using one or more processors, a correct translation for each segment based on the plurality of translations associated with the segment.

2. The method of claim 1, wherein accessing the content includes accessing a web server containing online content.

3. The method of claim 1, wherein identifying the plurality of segments within the content includes identifying a plurality of sentences within the content.

4. The method of claim 1, further comprising:
assigning a difficulty level to each of the plurality of segments; and
determining a language skill level associated with each of the plurality of users.

5. The method of claim 4, wherein providing each of the plurality of segments to the plurality of users is based on the difficulty level of each of the plurality of segments and the language skill level associated with each of the plurality of users.

6. The method of claim 1, wherein providing each of the plurality of segments to the plurality of users includes selecting a segment that advances the language education of each user.

7. The method of claim 1, wherein providing each of the plurality of segments to the plurality of users includes displaying the segment to the user in the user's native language.

8. The method of claim 1, wherein providing each of the plurality of segments to the plurality of users includes displaying the segment to the user in a non-native language of the user.

9. The method of claim 1, wherein each segment includes a plurality of words.

10. The method of claim 9, further comprising:
receiving a user request for translation of a selected word in a segment; and
presenting a translation of the selected word to the user.

11. The method of claim 1, wherein determining the correct translation for each segment includes identifying a most common translation associated with each of the plurality of segments.

12. The method of claim 1, wherein determining the correct translation for each segment includes having a portion of the plurality of users vote for a best translation.

13. The method of claim 1, further comprising storing the correct translation for each of the plurality of segments.

14. The method of claim 1, further comprising combining the correct translation for each of the plurality of segments within the content to create a translated version of the accessed content.

15. A method comprising:
accessing image content to be annotated in a first language;
providing the image content to a plurality of users coupled to a data communication network;
requesting each of the plurality of users to annotate the image content in the first language;
receiving via the data communication network a plurality of annotations associated with the image content; and
determining, using one or more processors, at least one correct annotation for the image content based on the plurality of annotations associated with the image content.

16. The method of claim 15, wherein the first language is a non-native language of the plurality of users.

17. The method of claim 15, further comprising:
assigning a difficulty level to the image content; and
determining a language skill level associated with each of the plurality of users.

18. The method of claim 17, wherein providing the image content to a plurality of users is based on the difficulty level of the image content and the language skill level associated with each of the plurality of users.

19. The method of claim 15, wherein accessing image content includes accessing video content from a web server.

20. An apparatus comprising:
a communication module configured to access content in a first language;
a content segmentation module configured to identify a plurality of segments within the content;
a segment translation manager configured to provide each of the plurality of segments to a plurality of users, to request each of the plurality of users to translate the provided segment from the first language to a second language, and to receive a plurality of translations associated with each of the plurality of segments, the segment translation manager further to determine a correct translation for each segment based on the plurality of translations associated with the segment; and
a storage device coupled to the segment translation manager and configured to store the correct translation for each of the plurality of segments.
